(19) United States
(12) Patent Application Publication
(10) Pub. No.: US 2010/0255391 A1
(43) Pub. Date: Oct. 7, 2010

(54) FUEL CELL STRUCTURE HAVING COMBINED POLAR PLATES AND THE COMBINED POLAR PLATES THEREOF

(75) Inventors: Feng-Chang CHEN, Taipei (TW); Sz-Sheng WANG, Taipei (TW); Wen-Hsin CHIU, Taipei (TW); Yen-Yu CHEN, Taipei (TW); Chi-Bin WU, Taipei (TW)

Correspondence Address: Juan Carlos A. Marquez;c/o Stites & Harbison PLLC, 1199 North Fairfax Street, Suite 900, Alexandria, VA, 22314-1437, US

(73) Assignee: Chung-Hsin Electric and Machinery Manufacturing Corp., Jhonghe City (TW)

(21) Appl. No.: 12/464,959

(22) Filed: May 13, 2009

(30) Foreign Application Priority Data
Apr. 1, 2009 (TW) 098110859

(51) Int. Cl. H01M 8/10; H01M 2/02

(52) U.S. Cl. 429/414; 429/483

(57) ABSTRACT

A fuel cell structure having combined polar plates and the combined polar plate thereof are disclosed. The fuel cell structure includes a membrane electrode assembly, the combined polar plate, and a charge collection plate. The combined polar plate and the charge collection plate are arranged on outer surfaces of the membrane electrode assembly. The combined polar plate includes a non-porous plate and a porous plate. The non-porous plate has a base plate and a frame which together define a recess. A portion of the base plate free of the frame has at least one flow channel. The porous plate is received in the recess and sandwiched between the membrane electrode assembly and the base plate. Pores of the porous plate increase flow rate of fuel, and the flow channel drains water, a product of electrochemical reaction, from the fuel cell structure quickly to enhance performance of power generation.

### BACKGROUND OF THE INVENTION

1. Field of the Invention

The present invention relates to fuel cell structures having combined polar plates and the combined polar plates thereof. More particularly, the present invention relates to a fuel cell structure configured for use with a fuel cell and provided with combined polar plates and also relates to the combined polar plate thereof.

2. Description of the Prior Art

Owing to two advantages of fuel cells, namely high efficiency and low pollution, research and development of fuel cells is growing at a global level. A polymer electrolyte membrane fuel cell (PEMFC), which operates at low temperature (below 100° C.), is the simplest of its kind to apply to system integration in terms of selection of materials, temperature control, safeguarding security, and system maintenance. As being conducive to reduction of system integration costs, PEMFC is one of the key topics for worldwide research and development on energy resources.

FIG. 1 is a cross-sectional view of a conventional fuel cell structure 10. As shown in the drawing, the conventional fuel cell structure 10 comprises a membrane electrode assembly 11 and a pair of bipolar plates 12. The membrane electrode assembly 11 comprises a proton exchange membrane 111, a pair of catalyst layers 112, an anode 113, and a cathode 114. The catalyst layers 112 flank the proton exchange membrane 111 and are sandwiched between the anode 113 and the cathode 114. The membrane electrode assembly 11 is sandwiched between the bipolar plates 12. Fuel flow channels 121 are provided on inner sides of the bipolar plates 12 to have access to the membrane electrode assembly 11. The fuel flow channels 121 enable oxygen and hydrogen to be delivered to the anode 113 and the cathode 114, respectively, and enable electrochemical reaction to take place in the membrane electrode assembly 11. Hence, the area and shape of the cross section, together with the length of the fuel flow channels 121, jointly determine whether oxygen and hydrogen flow smoothly and come into contact with the membrane electrode assembly 11 uniformly, in turn deciding the extent of the electrochemical reaction between fuel and the membrane electrode assembly 11 as well as the performance of power generation.

Taiwan Patent No. 553496, entitled “Membrane Fuel Cell with Porous Bipolar Plates”, has taught the following technical features: each of the porous bipolar plates comprises two porous metal plates and a non-porous metal plate sandwiched therebetween, wherein the porous metal plates and the non-porous metal plate are made of the same material, otherwise performance of power generation will be compromised. Despite its attempt to overcome drawbacks of the prior art by enabling fuel to flow freely by means of pores of the bipolar plates and extending the duration of the electrochemical reaction, Taiwan Patent No. 553496 has its own drawbacks. Among others, power generation can be effectuated only if the porous metal plates and the non-porous metal plate are made of the same material, and more particularly, made of a metallic material capable of electrical conduction; otherwise, the performance of power generation will be compromised. Besides, the electrochemical reaction can overheat the porous metal plates and the non-porous metal plate and thereby compromise the performance of power generation, shorten service life, and bring risks.

In an attempt to overcome the above drawbacks of the prior art, Taiwan Published Patent Application No. 200822434, entitled “Fuel Cell with Composite Porous Polar Plate”, has taught a technique wherein a charge collection plate of a fuel cell essentially comprises one or more porous plates and at least one non-porous plate, in which the one or more porous plates and the at least one non-porous plate can be made of different materials. The fuel cell structure disclosed in Taiwan Published Patent Application No. 200822434 has the advantages including freeing flow of fuel and diffusion thereof to electrodes via the pores of the porous plates; replacing of conventional bipolar plates by composite porous polar plates to thereby reduce volume, weight, costs and shorten processing time; and providing diverse choice of materials as the porous plate and the non-porous plate can be made of different materials.

Membrane fuel cells usually have an internal temperature of less than 100° C. and thereby produce a reaction product, that is, water, in the form of liquid. In the situation where water produced by electrochemical reaction is too much to be timely discharged, the water accumulates in the composite porous polar plate and causes flooding, and in consequence the pores of the porous polar plate clog up. The clogging of the pores on the porous polar plate causes feeding of fuel that sustains electrochemical reaction to become inefficient and discontinuous, and thus the performance of power generation deteriorates.

### SUMMARY OF THE INVENTION

The present invention provides a fuel cell structure having combined polar plates and the combined polar plate thereof, wherein the combined polar plate has at least one flow channel for discharging water out of the fuel cell structure quickly and thereby preventing the fuel cell structure from accumulating water.

The present invention provides a fuel cell structure having combined polar plates and the combined polar plate thereof, wherein the combined polar plate has at least one flow channel for preventing pores of a porous plate of the combined polar plate from clogging and thereby allowing fuel to react efficiently with a view to enhancing performance of power generation.

To achieve the above and other objectives, the present invention provides a fuel cell structure having combined polar plates. The fuel cell structure comprises: a membrane electrode assembly comprising a proton exchange membrane, a pair of catalyst layers flanking the proton exchange membrane, and a pair of electrode layers disposed on outer surfaces of the catalyst layers, respectively; a first combined polar plate disposed on a first outer surface of the membrane electrode assembly and comprising: a first non-porous plate including a first base plate and a first frame coupled thereto so as for a first recess to be defined by the first base plate and the first frame together and at least one first flow channel to be formed in a portion of the first base plate not in contact with the first frame; and at least one first porous plate received in the first recess and thereby sandwiched between the membrane electrode assembly and the first base plate; and a charge collection plate disposed on a second outer surface of the membrane electrode assembly.

To achieve the above and other objectives, the present invention provides a combined polar plate for use with a fuel cell. The combined polar plate comprises: a non-porous plate comprising a base plate and a frame coupled thereto so as for a recess to be defined by the base plate and the frame together and at least one flow channel to be formed in a portion of the base plate not in contact with the frame; and at least one porous plate received in the recess.

Implementation of the present invention at least leads to the following effects:

1. Provided with at least one flow channel, a combined polar plate is prevented from accumulating water.

2. A reaction product of electrochemical reaction can quickly flow out of a fuel cell structure via the flow channel.

3. Pores of a porous plate of the combined polar plate are prevented from being clogged with water, allowing fuel to undergo the electrochemical reaction inside the fuel cell efficiently and performance of power generation to be enhanced significantly.

### BRIEF DESCRIPTION OF THE DRAWINGS

To enable persons skilled in the art to gain insight into the objectives, features, and advantages of the present invention readily and therefore be capable of implementing the present invention according to the disclosure contained in the specification, the present invention is hereunder illustrated with preferred embodiments in conjunction with the accompanying drawings, wherein:

FIG. 1 is a cross-sectional view of a conventional fuel cell structure;

FIG. 2 is an exploded view of a fuel cell structure having combined polar plates according to the present invention;

FIG. 3 is a cross-sectional view of the fuel cell structure having combined polar plates according to the present invention;

FIG. 4A is a cross-sectional view of a first embodiment of a combined polar plate according to the present invention;

FIG. 4B is a cross-sectional view of a second embodiment of the combined polar plate according to the present invention;

FIG. 5A is a perspective view of a first embodiment of a non-porous plate according to the present invention;

FIG. 5B is a perspective view of a second embodiment of the non-porous plate according to the present invention;

FIG. 5C is a perspective view of a third embodiment of the non-porous plate according to the present invention;

FIG. 5D is a perspective view of a fourth embodiment of the non-porous plate according to the present invention;

FIG. 5E is a perspective view of a fifth embodiment of the non-porous plate according to the present invention; and

FIG. 6 is an exploded cross-sectional view of the fuel cell structure having combined polar plates according to the present invention.

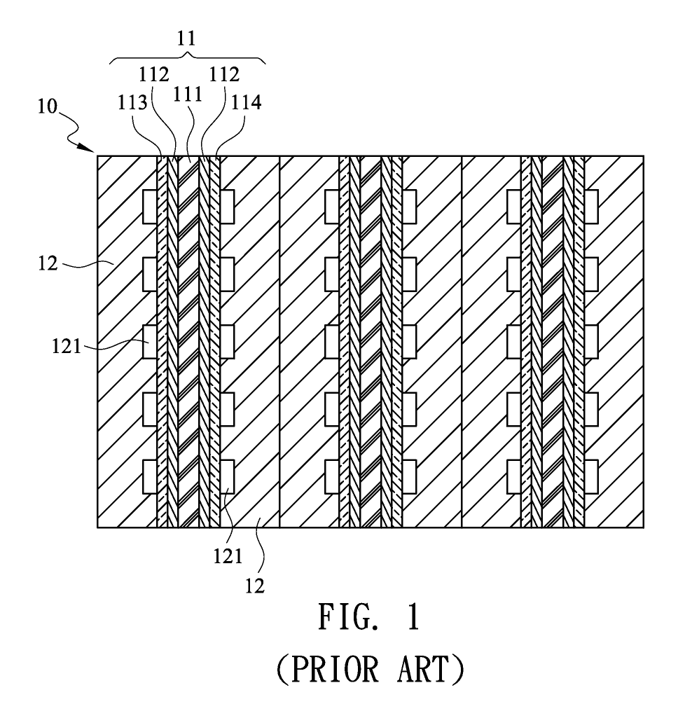

### DETAILED DESCRIPTION OF THE EMBODIMENTS

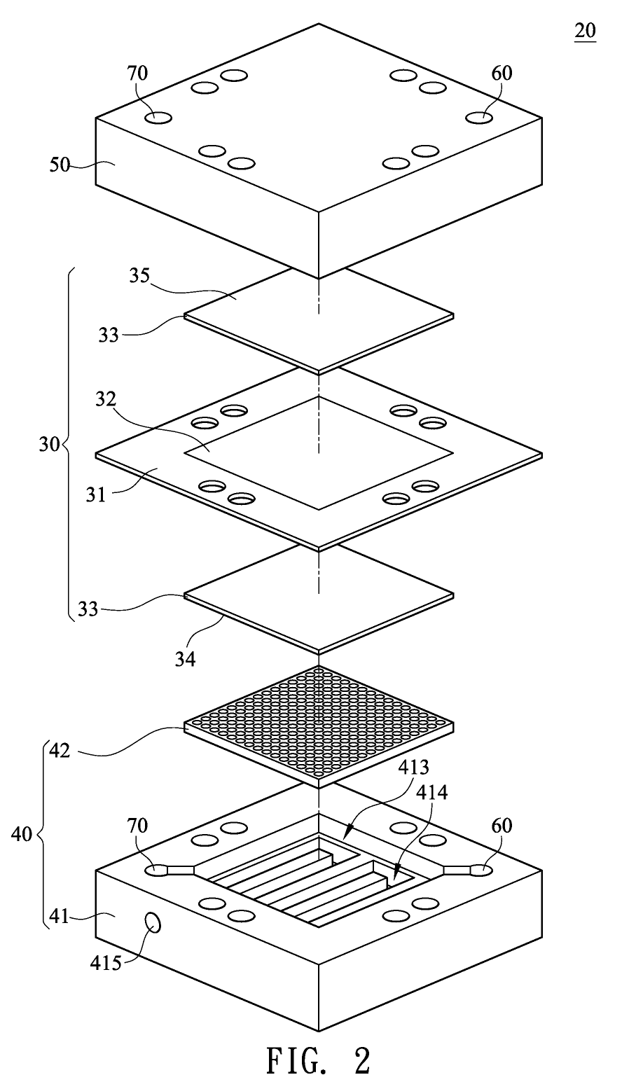

Referring to FIG. 2, which is an exploded view of a fuel cell structure having combined polar plates according to the present invention, in an embodiment, a fuel cell structure 20 having combined polar plates comprises a membrane electrode assembly 30, a first combined polar plate 40, and a charge collection plate 50.

As shown in FIG. 2, the membrane electrode assembly 30 comprises a proton exchange membrane 31, a pair of catalyst layers 32, and a pair of electrode layers 33. The proton exchange membrane 31 functions as an interface whereby protons move from the anode to the cathode of the electrode layers 33. The catalyst layers 32 flank the proton exchange membrane 31. The electrode layers 33 are disposed on the outer surfaces of the catalyst layers 32, respectively.

A fuel inlet hole 60 and a fuel outlet hole 70 are formed in the first combined polar plate 40 or the charge collection plate 50. Hence, fuel (hydrogen) and an oxidizing agent (oxygen or air) enter the fuel cell structure 20 via the fuel inlet hole 60 and leave the fuel cell structure 20 via the fuel outlet hole 70. Decomposition of hydrogen occurs in the presence of the catalyst layers 32 and results in products, namely protons and electrons. The resultant protons move to the cathode via the proton exchange membrane 31. The resultant electrons travel along an external circuit to form a flowing electrical current carrying electrical energy. Oxygen, the protons having passed the proton exchange membrane 31, and the returning electrons undergo electrochemical reaction to generate heat and produce the reaction product, that is, water.

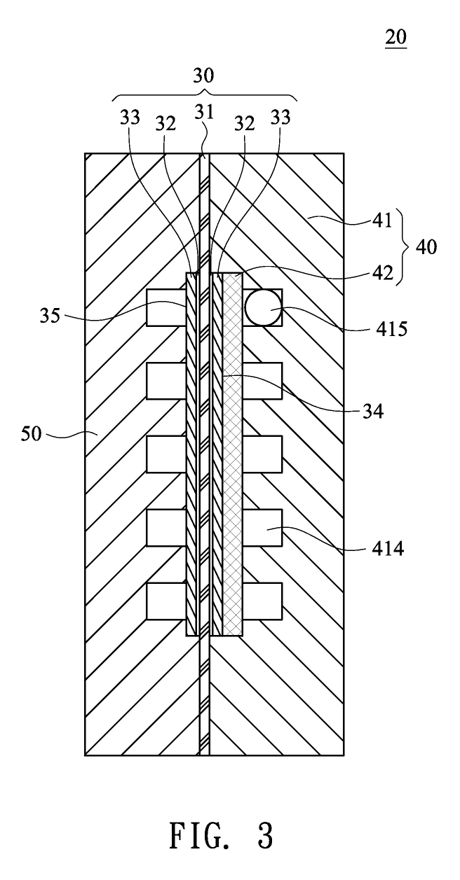

Referring to FIG. 3, the first combined polar plate 40 is disposed on a first outer surface 34 of the membrane electrode assembly 30 and comprises a first non-porous plate 41 and at least one first porous plate 42.

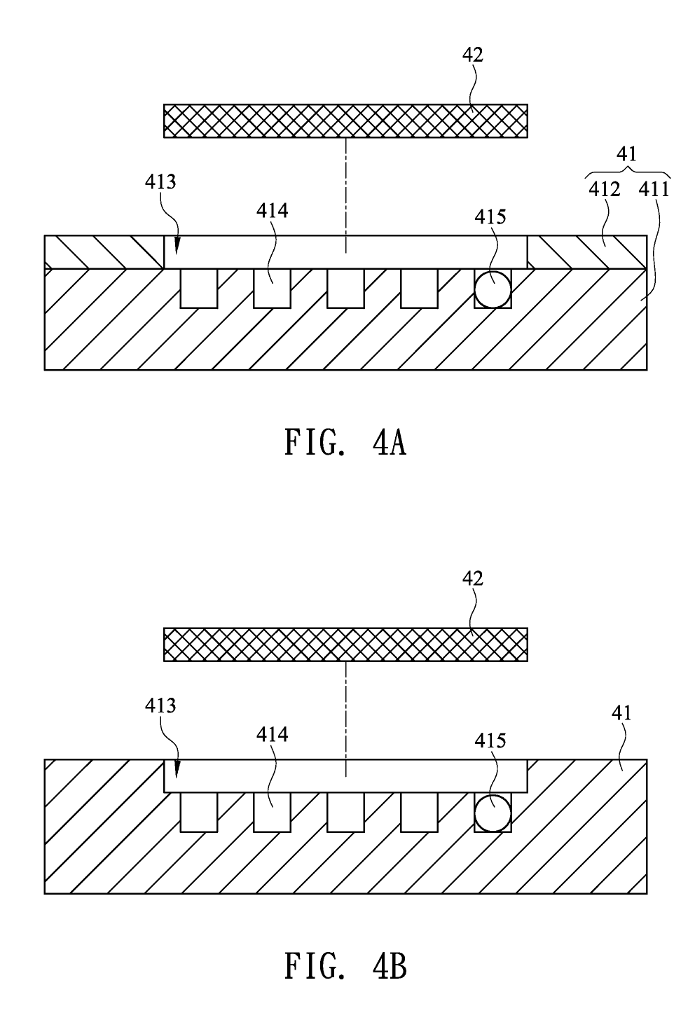

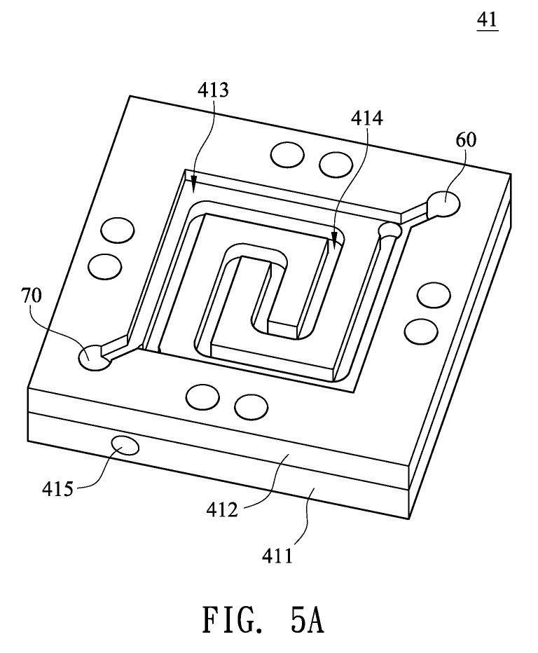

Referring to FIG. 4A, the first non-porous plate 41 is made of an electrically conductive material or an electrically non-conductive material and comprises a first base plate 411 and a first frame 412 coupled thereto. The first frame 412 and the first base plate 411 together define a first recess 413. A portion of the first base plate 411 is not in contact with the first frame 412 but is formed with at least one first flow channel 414 for draining water from the fuel cell structure 20 quickly so as to prevent accumulation of water. Referring to FIG. 4B, to simplify the structure of the first non-porous plate 41, the first base plate 411 and the first frame 412 are integrally formed as a one-piece unit.

Referring to FIGS. 3, 4A, and 4B, the first porous plate 42 is received in the first recess 413, and dimensions of the first porous plate 42 match that of the first recess 413 so as for the first porous plate 42 to be sandwiched between the membrane electrode assembly 30 and the first base plate 411. Hence, the fuel and oxidizing agent fed into the fuel cell structure 20 via the fuel inlet hole 60 are delivered via the pores of the first porous plate 42, and a reaction product of electrochemical reaction, water, is drained from the fuel cell structure 20 quickly via the pores of the first porous plate 42.

The first porous plate 42 is made of an electrically conductive material or an electrically non-conductive material. The first porous plate 42 and the first non-porous plate 41 are made of the same material or different materials as needed. Hence, the first combined polar plate 40 is capable of electrical conduction, composed of components which are cheap, lightweight, and easy to fabricate, and thereby being conducive to elimination of a drawback of the prior art, namely bulky heavy conventional bipolar plates. Also, the first porous plate 42 is good at gas feeding and water drainage, and thus the first combined polar plate 40 incurs low costs but has high performance.

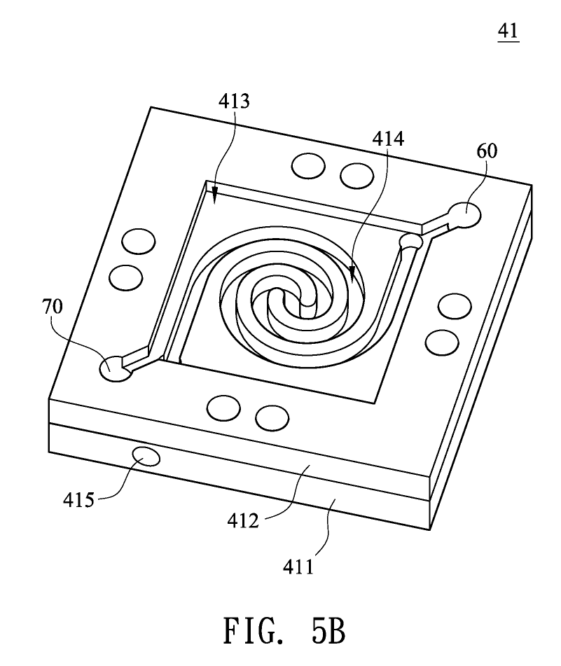

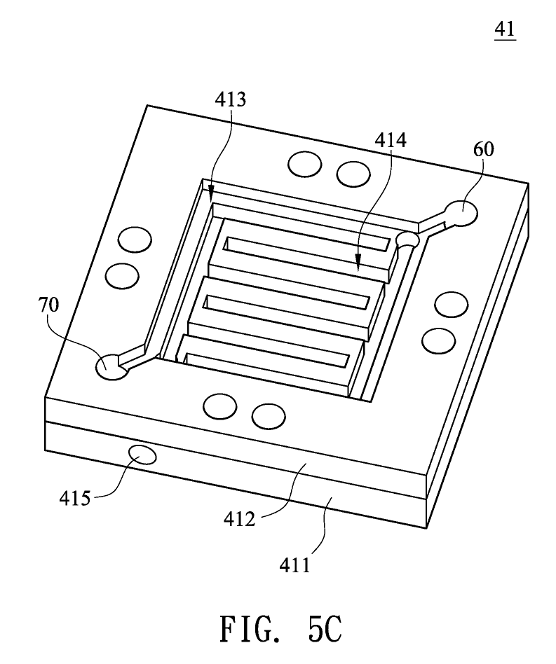

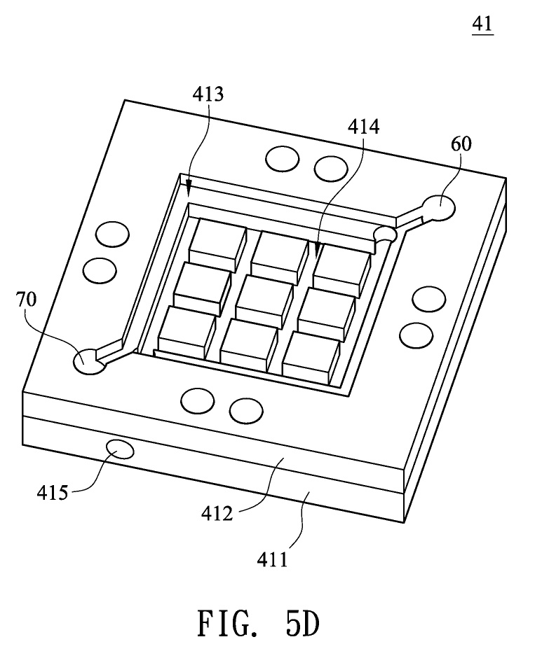

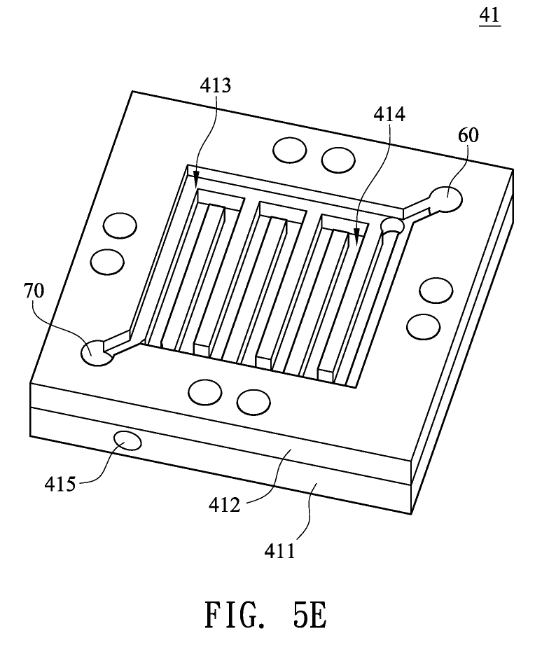

The present invention overcomes another drawback of the prior art because of the good performance of the fuel cell structure 20 in power generation. Water, a reaction product of electrochemical reaction, drains away quickly and therefore does not accumulate in the margin of the first combined polar plate 40. Hence, clogged pores of the first porous plate 42 and resultant deteriorated performance of power generation are unlikely to occur to the fuel cell structure 20 of the present invention. In addition, since the first flow channel 414 formed in the first base plate 411 drains water from the fuel cell structure 20 quickly, not only does fuel flow swiftly, but water is distributed in the fuel cell structure 20 uniformly enough to be drained away rapidly. To improve speed of drainage, the pattern of the first flow channel 414 is convoluted (as shown in FIG. 5A), snaky (as shown in FIG. 5B), zigzag (as shown in FIG. 5C), grid-like (as shown in FIG. 5D), or parallel (as shown in FIG. 5E), though not limited thereto.

Compared to a conventional fuel cell structure, an embodiment of the fuel cell structure 20 features a 50% increase in performance of power generation, as a result of the first flow channel 414 configured to prevent accumulation of water and smooth the flow of fuel in the fuel cell structure 20.

To enable the fuel cell structure 20 to be effective in dissipating heat and draining water, the first non-porous plate 41 is provided with a multi-inlet device for dissipating heat, feeding gas, exhausting gas, or draining water, or, alternatively, the first base plate 411 is provided with at least one first water draining aperture 415 in communication with the first flow channel 414 such that water introduced into the first flow channel 414 can be drained from the fuel cell structure 20 via the first water draining aperture 415.

Referring to FIGS. 2 and 3, the charge collection plate 50 is disposed on a second outer surface 35 of the membrane electrode assembly 30 so as to allow the membrane electrode assembly 30 to be sandwiched between the first combined polar plate 40 and the charge collection plate 50. The charge collection plate 50 is a bipolar plate or a second combined polar plate 80, wherein the bipolar plate is a conventional bipolar plate and therefore is not described in detail herein.

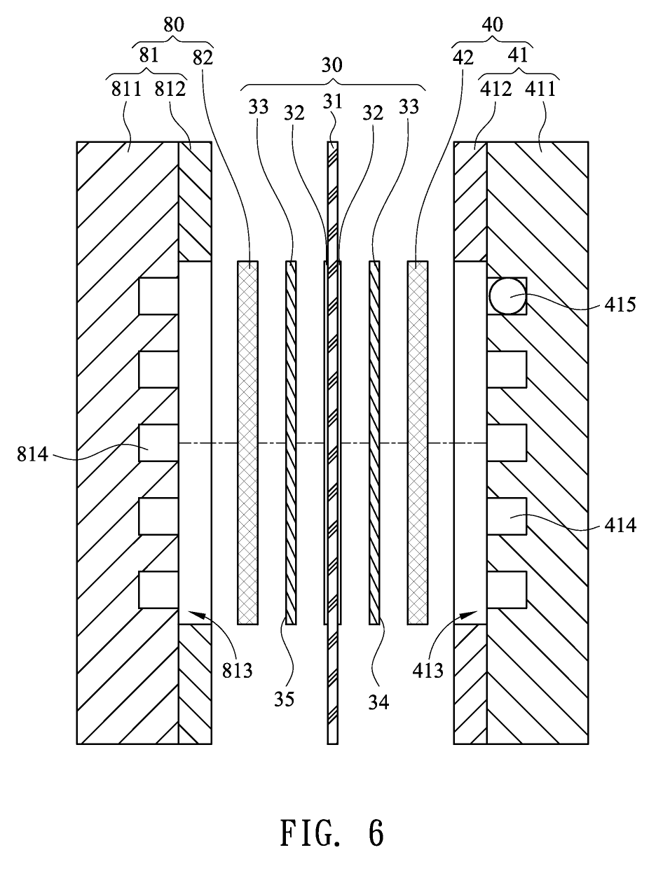

Referring to FIG. 6, the second combined polar plate 80 is disposed on the second outer surface 35 of the membrane electrode assembly 30 so as to allow the membrane electrode assembly 30 to be sandwiched between the first combined polar plate 40 and the second combined polar plate 80. The second combined polar plate 80 comprises a second non-porous plate 81 and at least one second porous plate 82.

The second non-porous plate 81 comprises a second base plate 811 and a second frame 812 coupled thereto. The second frame 812 and the second base plate 811 together define a second recess 813. A portion of the second base plate 811 is not in contact with the second frame 812 but is formed with at least one second flow channel 814. Like the first base plate 411 and first frame 412, the second base plate 811 and second frame 812 are integrally formed as a one-piece unit. Like the first flow channel 414, the second flow channel 814 drains water from the fuel cell structure 20 quickly and therefore the pores of the second porous plate 82 are unlikely to be clogged with water, thereby enhancing the performance of the fuel cell structure 20 in power generation.

The second flow channel 814 formed in the second base plate 811 and configured to drain water from the fuel cell structure 20 quickly. Thus, water is prevented from accumulating in the margin of the second combined polar plate 80, and the pores of the second porous plate 82 is free from the risk of getting clogged with water. As a result, the performance of the fuel cell structure 20 in power generation is ensured. To sum up, in so doing, not only does fuel flow swiftly, but water is distributed in the fuel cell structure 20 uniformly enough to be drained away rapidly. To improve speed of drainage as the first flow channel 414 does, the pattern of the second flow channel 814 is convoluted (as shown in FIG. 5A), snaky (as shown in FIG. 5B), zigzag (as shown in FIG. 5C), grid-like (as shown in FIG. 5D), or parallel (as shown in FIG. 5E), though not limited thereto.

To enhance speed of drainage, the second base plate 811 is provided with at least one second water draining aperture (not shown) in communication with the second flow channel 814 such that water introduced into the second flow channel 814 can be drained from the fuel cell structure 20 via the second water draining aperture.

The second porous plate 82 is received in the second recess 813 and thereby sandwiched between the membrane electrode assembly 30 and the second base plate 811. The second non-porous plate 81 and the second porous plate 82 of the second combined polar plate 80 are made of an electrically conductive material or an electrically non-conductive material. The second combined polar plate 80 and the first combined polar plate 40 have components in common, and are equal in functions of the components and the ways the components are coupled to one another; hence, detailed description of the second combined polar plate 80 is omitted herein.

The foregoing specific embodiments are illustrative of the features and functions of the present invention with a view to allowing persons skilled in the art to gain insight into and carry out the present invention but are not intended to restrict the scope of the present invention. It is apparent to those skilled in the art that all equivalent modifications and variations made in the foregoing embodiments according to the spirit and principle in the disclosure of the present invention should fall within the scope of the appended claims.

What is claimed is:

1. A fuel cell structure having combined polar plates, comprising:
a membrane electrode assembly comprising:
a proton exchange membrane;
a pair of catalyst layers flanking the proton exchange membrane; and
a pair of electrode layers disposed on outer surfaces of the catalyst layers, respectively;
a first combined polar plate disposed on a first outer surface of the membrane electrode assembly and comprising:
a first non-porous plate comprising:
a first base plate; and
a first frame coupled to the first base plate so as for a first recess to be defined by the first base plate and the first frame together and at least one first flow channel to be formed in a portion of the first base plate not in contact with the first frame; and
at least one first porous plate received in the first recess and thereby sandwiched between the membrane electrode assembly and the first base plate; and
a charge collection plate disposed on a second outer surface of the membrane electrode assembly.

2. The fuel cell structure of claim 1, wherein the first base plate and the first frame are integrally formed as a one-piece unit.

3. The fuel cell structure of claim 1, wherein a pattern of the first flow channel is convoluted, snaky, zigzag, grid-like, or parallel.

4. The fuel cell structure of claim 1, wherein the first porous plate is made of an electrically conductive material or an electrically non-conductive material.

5. The fuel cell structure of claim 1, wherein the first non-porous plate is made of an electrically conductive material or an electrically non-conductive material.

6. The fuel cell structure of claim 1, wherein the first base plate is provided with at least one first water draining aperture in communication with the first flow channel.

7. The fuel cell structure of claim 1, wherein the charge collection plate is a bipolar plate or a second combined polar plate.

8. The fuel cell structure of claim 7, wherein the second combined polar plate comprises:
a second non-porous plate comprising:
a second base plate; and
a second frame coupled to the second base plate so as for a second recess to be defined by the second base plate and the second frame together and at least one second flow channel to be formed in a portion of the second base plate not in contact with the second frame; and
at least one second porous plate received in the second recess and thereby sandwiched between the membrane electrode assembly and the second base plate.

9. The fuel cell structure of claim 8, wherein the second base plate and the second frame are integrally formed as a one-piece unit.

10. The fuel cell structure of claim 8, wherein a pattern of the second flow channel is convoluted, snaky, zigzag, grid-like, or parallel.

11. The fuel cell structure of claim 8, wherein the second porous plate is made of an electrically conductive material or an electrically non-conductive material.

12. The fuel cell structure of claim 8, wherein the second non-porous plate is made of an electrically conductive material or an electrically non-conductive material.

13. The fuel cell structure of claim 8, wherein the second base plate is provided with at least one second water draining aperture in communication with the second flow channel.

14. A combined polar plate for use with a fuel cell, comprising:
a non-porous plate comprising:
a base plate; and
a frame coupled to the base plate so as for a recess to be defined by the base plate and the frame together and at least one flow channel to be formed in a portion of the base plate not in contact with the frame; and
at least one porous plate received in the recess.

15. The combined polar plate of claim 14, wherein the base plate and the frame are integrally formed as a one-piece unit.

16. The combined polar plate of claim 14, wherein a pattern of the flow channel is convoluted, snaky, zigzag, grid-like, or parallel.

17. The combined polar plate of claim 14, wherein the non-porous plate is made of an electrically conductive material or an electrically non-conductive material.

18. The combined polar plate of claim 14, wherein the porous plate is made of an electrically conductive material or an electrically non-conductive material.

19. The combined polar plate of claim 14, wherein the base plate is provided with at least one water draining aperture in communication with the flow channel.
